(19) United States
(12) Patent Application Publication
(10) Pub. No.: US 2026/0084908 A1
(43) Pub. Date: Mar. 26, 2026

(54) DEVICE AND METHOD FOR UNSTACKING A STACK

(71) Applicant: Heidelberger Druckmaschinen AG, Heidelberg (DE)

(72) Inventors: Dennis D'Angelo, Murr (DE); Stefan Dettke, Stuttgart (DE); Suat Demir, Walldorf (DE); Axel Diehl, Wiesbaden (DE); Michael Diews, Birkenau (DE); Stefan Hasenzahl, Heidelberg (DE); Dominik Knöbl, Angelbachtal (DE); Stefan Maier, Dielheim (DE); Ralf März, Angelbachtal (DE); Stefan Mutschall, Östringen (DE); Steffen Neeb, Bensheim (DE); Michael Östreicher, Eppelheim (DE); Christian Wiersema, Leimen (DE); Simon Gianni Zocco, Nussloch (DE)

(21) Appl. No.: 19/341,185

(22) Filed: Sep. 26, 2025

(30) Foreign Application Priority Data
Sep. 24, 2024 (DE) 10 2024 127 903.6

(51) Int. Cl. B65G 59/02

(52) U.S. Cl. CPC B65G 59/023

(57) ABSTRACT

A device for unstacking a stack that is constructed of part-stacks of flat printed products arranged next to one another and on top of one another. The device has a separating apparatus for forming a gap between a respective part-stack and the stack, and a gripping apparatus for gripping and lifting the respective part-stack utilizing the gap. A first robot moves the gripping apparatus during unstacking and a second robot moves the separating apparatus separately. The two robots may be structurally identical gantry robots on a common gantry frame. The processing speed may be increased when depalletizing stacks due to process parallelization. The unstacking process is particularly suitable in a postpress context where printed products are further processed.

### CROSS-REFERENCE TO RELATED APPLICATION

This application claims the priority, under 35 U.S.C. § 119, of German Patent Application DE 10 2024 127 903.6, filed Sep. 26, 2024; the prior application is herewith incorporated by reference in its entirety.

### FIELD AND BACKGROUND OF THE INVENTION

The invention relates to a device for unstacking, or depalletizing, a stack that is formed of part-stacks of flat printed products arranged next to one another and on top of one another.

The invention belongs to the technical field of the graphics industry and therein, in particular, to the sector of handling (e.g., gripping, holding, lifting off, moving, and setting down) stacks of flat products which are on top of one another, flexible, and preferably printed and punched, such as, e.g., printed sheets or punching blanks, preferably made of paper, cardboard, paperboard, plastic, or composite materials, using a manipulator, in particular a robot with a robotic arm and a gripper apparatus for the stacks.

Depalletizing stacks of sheets utilizing robotics technology and separating the stacks section by section before gripping and lifting off are already known in the pertinent art.

International published patent application WO 2017/177393 A1 discloses a depalletizing system for a stack with a robotic arm and a gripper head which is arranged on the robotic arm and is moved thereby during depalletizing. The gripper head as a gripping apparatus comprises an upper gripper and a lower gripper. Further, the gripper head comprises a separating apparatus designed as a hook. Thus, the gripping apparatus and the separating apparatus are collectively moved by the same robotic arm, and the robot must be sized correspondingly.

Employing multiple robots during depalletizing is also already known.

In the sector of palletizing/depalletizing, published patent applications US 2010/0146907 A1 and US 2017/0173800 A1 each disclose a system in which two identical robots are employed, i.e., the robots along with their tools are constructed identically and carry out the same tasks (individually or collectively).

On the part of the manufacturers of graphics articles—that is, e.g., print shops with prepress, printing itself, and post-press—there is a constant desire for enhanced production speeds, which is why robotics technology is employed more and more. Further, this may allow staff savings or stand in for absent staff.

### SUMMARY OF THE INVENTION

It is accordingly an object of the invention to provide a unstacking device and method which overcomes the above-mentioned disadvantages of the heretofore-known devices and methods of this general type and which provides for an improvement as compared to the state of the art and, in particular, enables increasing the processing speed when depalletizing stacks.

With the above and other objects in view there is provided, in accordance with the invention, a device for unstacking a stack, wherein the stack is formed of part-stacks of flat printed products arranged next to one another and on top of one another. The device comprises:
a separating apparatus configured for forming a gap between a respective part-stack and a remainder of the stack;
a gripping apparatus for gripping the respective part-stack via the gap formed between the respective part-stack and the remainder of the stack;
a first robot configured to move said gripping apparatus during the unstacking; and
a second robot configured to move said separating apparatus separately.

In other words, a first device for unstacking (alternatively: depalletizing) a stack according to the invention, wherein the stack is constructed of part-stacks of flat printed products arranged next to one another and on top of one another, wherein the device comprises a separating apparatus for preferably temporarily forming a gap between a respective part-stack and the stack, and a gripping apparatus for gripping and preferably lifting the respective part-stack off utilizing the respective gap, and wherein the device comprises a first robot which moves the gripping apparatus during unstacking, is characterized in that the device comprises a second robot which moves the separating apparatus separately.

With the above and other objects in view there is provided, in accordance with the invention, a device for unstacking a stack which comprises:
a first robot having a gripper apparatus; and
a second robot having a separating apparatus.

In other words, a second device for unstacking a stack according to the invention, wherein the stack is constructed of part-stacks of flat printed products arranged next to one another and on top of one another, and wherein the device comprises a first robot with a gripper apparatus, is characterized in that the device comprises a second robot with a separating apparatus.

Finally, with the above and other objects in view there is also provided a method for unstacking a stack, the method comprising:
providing a stack that is formed of part-stacks of flat printed products arranged next to one another and on top of one another;
first individually separating the part-stacks from the stack by forming a gap with a separating apparatus that is arranged on a first robot and moved by the first robot; and
subsequently gripping and lifting off the part-stacks by a gripping apparatus arranged on a second robot and moved by the second robot.

In other words, the method for unstacking a stack according to the invention, wherein the stack is constructed of part-stacks of flat printed products arranged next to one another and on top of one another, wherein the part-stacks are successively first separated from the stack by forming a gap and then gripped and lifted off, is characterized in that the separating is effected by a separating apparatus arranged on a first robot and moved thereby, and that the gripping and lifting off is effected by a gripping apparatus arranged on a second robot and moved thereby.

Advantageous, and therefore preferred, further developments of the inventions result from the dependent claims as well as from the description and the drawings.

In an advantageous manner, the invention enables increasing the processing speed when depalletizing stacks. The invention is employed, e.g., in the postpress sector (further processing of printed products).

The invention distributes the two process steps of separating and gripping to two pieces of handling equipment. By employing two robots, in an advantageous manner, the invention permits process steps during depalletizing to be parallelized, and thereby the speed, in particular the cycle times, of the operation to be enhanced. A further advantage of the invention is that structurally identical robots (with the various tools: gripping apparatus and separating apparatus) may be employed, whereby complexity and hence costs may be reduced.

The individual flat printed products may be folding-carton blanks, and it may be provided for them to be depalletized and then supplied to a folding-carton gluing machine. It may also be provided for the products to be depalletized and repalletized on a different pallet, e.g., to turn what are known as mixed pallets into unmixed pallets or, e.g., to generate a tighter packing pattern.

Preferred further developments of the invention (in short: further developments) as a first device are described below. These may—where they do not technically exclude each other—also be combined.

One further development may be characterized in that the gripping apparatus is designed as a gripping head which is arranged on the first robot in a movable manner. The gripping head may have a compact design. It may be provided that the gripping head is arranged on the first robot in a rotatable manner, in particular about a vertical axis. It may be provided that the gripping head comprises a gripper pair of a lower gripper and an upper gripper. In this context, the upper gripper may be movable back and forth towards the lower gripper, in particular in a vertical direction. It may be provided that the separating apparatus is designed as a separating head which is arranged on the second robot in a movable manner. The separating head may also have a compact design. It may be provided that the separating head is arranged on the second robot in a rotatable manner, again in particular about a vertical axis. It may be provided that the gap is formed between the bottom (bottommost printed product) of a respective part-stack and the top (topmost printed product) of the stack located underneath. It may be provided that the lower gripper is entirely or partly moved into the gap, in particular in a horizontal direction.

One further development may be characterized in that the separating head comprises a first lifter for lifting the part-stack in some areas and preferably temporarily and for generating the gap. The gap is preferably formed temporarily, i.e., only until the part-stack is gripped and then lifted off the stack, in particular a pallet stack. It may be provided that the first lifter touches the part-stack at a vertical side during lifting. The first lifter may act in a pressing manner. It may be provided that the separating head comprises a vertically movable second lifter for lifting the part-stack in some areas and preferably temporarily and for generating or continuing to generate the gap. Both lifters may be activated pneumatically. It may be provided that the second lifter touches the part-stack at a horizontal bottom during lifting, in particular grips it from below. It may be provided that the second lifter enters between the bottommost product of the part-stack and an intermediate layer located underneath, e.g., a cardboard sheet.

One further development may be characterized in that the separating head comprises at least one controllable drive for horizontally moving the first lifter and/or the second lifter. Preferably, a common drive is provided. It may be provided that the drive is an electric linear drive. It may be provided that the electric linear drive comprises at least three horizontal settings: in the first setting, both lifters are outside the part-stack in a passive position, in the second setting, only the first lifter is in its active position on the part-stack, and in the third setting, both lifters are in their respective active position on or below the part-stack, respectively.

One further development may be characterized in that the separating head comprises a vertically movable presser. It is preferably moved pneumatically. It may be provided that the separating head separates a part-stack from the stack at least in some areas, e.g., less than 10% or 5% or 1% of the surface area of the bottommost printed product. It may be provided that the separating head separates the part-stack from the stack only in the area of a bottom edge. It may be provided that the separating head generates a gap between the part-stack and the stack. The gap is preferably less than 10 mm or less than 5 mm in height. It may be provided that the part-stack separated from the stack continues to lie on top of the stack in the effective area of the presser. The effective area is that area where the presser pushes the part-stack downwards onto the stack. It may be provided that the gripping head or at least part of the gripping head enters the gap, in particular at least one tine of the gripping head.

One further development may be characterized in that the device comprises a digital computer which controls both the movement of the first robot and the activation of the gripping apparatus and the movement of the second robot and the activation of the separating apparatus such that a part-stack is first separated from the stack and then gripped. It may be provided that the separated and gripped part-stack is lifted off and moved away from the stack. It may be provided that the part-stack is set down elsewhere, that is, not at the location of the stack, e.g., at a further processing machine. It may be provided that the stack is constructed in accordance with a set-down scheme for the part-stacks, and that the digital computer controls both the movements of the first robot and the movements of the second robot during disassembling of the stack with recourse to the set-down scheme. The set-down scheme defines the respective position and the respective orientation of the individual part-stacks in the (total) stack, preferably also the X-Y-Z dimensions of the part-stacks. It may be provided that the device comprises a sensing apparatus, i.e., an apparatus for geometrically sensing the stack, an area of the stack, at least one part-stack, and/or an area of the at least one part-stack. It may be provided that the sensing apparatus is arranged on the device in a stationary manner. It may be provided that the sensing apparatus is arranged in a mobile manner, e.g., automatically adjustable. It may be provided that the sensing apparatus is arranged on the separating head. It may be provided that the sensing apparatus comprises at least one camera and/or one line scanner. It may be provided that the sensing apparatus provides data, and that the digital computer uses the data for target-actual comparison using the set-down scheme. In this context, the digital computer may detect whether the part-stacks have been incorrectly placed or have slipped and may preferably take this into account in a correcting manner during depalletizing.

One further development may be characterized in that the gripping head is arranged on the first robot. One further development may be characterized in that the first robot is controllable such that the gripping head is movable in three spatial directions: in a horizontal longitudinal direction X, in a horizontal transverse direction Y, and in a vertical upwards direction Z. It may be provided that the first robot is designed as a first gantry robot, in particular with three translational axes. Gantry robots make a cubic working space available, and this fits well with the process of unstacking an externally substantially cube-shaped stack from a (rectangular) pallet. It may be provided that the first gantry robot has a first longitudinal guide in the X direction. It may be provided that the first gantry robot has a first transverse guide in the Y direction. It may be provided that the first gantry robot has a first vertical guide in the Z direction. It may be provided that the first gantry robot has a first vertical support in the Z direction. It may be provided that the gripping head is arranged on the first vertical guide in a manner rotatable about at least a first axis of rotation. It may be provided that the first axis of rotation is a vertical axis.

One further development may be characterized in that the lower gripper comprises at least one tine. It may be provided that at least two tines are present, and that the tines are adjustable in format and/or exchangeable, e.g., manually or automatically. It may be provided that the upper gripper comprises at least one tine. It may be provided that at least two tines are present, and that the tines are adjustable in format and/or exchangeable, e.g., manually or automatically. It may be provided that the upper gripper is movable relative to the lower gripper, preferably pneumatically. It may be provided that the upper gripper is vertically movable.

One further development may be characterized in that the gripping head comprises the lower gripper, the upper gripper, and a drive for the movable upper gripper. It may be provided that the drive is a hydraulic cylinder. It may be provided that the drive is controllable.

One further development may be characterized in that the separating head is arranged on the second robot. It may be provided that the second robot is controllable such that the separating head is movable in the three spatial directions X, Y, and Z. It may be provided that the second robot is designed as a second gantry robot, in particular with three translational axes. It may be provided that the second gantry robot has a second longitudinal guide in the X direction. It may be provided that the second gantry robot has a second transverse guide in the Y direction. It may be provided that the second gantry robot has a second vertical guide in the Z direction. It may be provided that the second gantry robot has a second vertical support in the Z direction. It may be provided that the separating head is arranged on the second vertical guide in a manner rotatable about at least a second axis of rotation. It may be provided that the second axis of rotation is a vertical axis.

One further development may be characterized in that the movements of the gripper apparatus and/or the movements of the separating apparatus span a common working space. In this context, the working space may be defined by the sum of all reachable or all necessarily reachable locations in the X-Y-Z space. It may be provided that the stack is entirely or at least partly placed in the working space for disassembling.

One further development may be characterized in that the first robot and the second robot are designed as gantry robots and are arranged on a common gantry frame. This arrangement decreases the risk of robot collisions compared to two jointed-arm robots cooperating. Further, the gantry frame preferably defines a safety area which operating staff is not allowed to enter during operation and which is preferably access-monitored for this purpose. It may be provided that the gantry frame comprises multiple, in particular four, pillars which span a preferably cubic intermediate space. It may be provided that the working space is in the intermediate space, in particular, that the working space is smaller than the intermediate space. It may be provided that the first robot and the second robot are structurally identical. It may be provided that the stack is constructed on a pallet, and that the pallet is placed in the intermediate space for disassembling of the stack, preferably on a floor or a conveying apparatus of the production site. It may be provided that the pallet is movable into the intermediate space from at least one side. It may be provided that the pallet is movable into the intermediate space from two or three sides. It may be provided that moving the pallet takes place in an automated manner using a mobile AVG (automated guided vehicle) or in an automated manner using a pallet conveying apparatus fastened on or in a floor.

Preferred further developments of the invention (in short: further developments) as a second device are described below. These, too, may—where they do not technically exclude each other—also be combined.

One further development may be characterized in that the device comprises a third robot with a further gripping apparatus. It may be provided that the first robot and the second robot are designed as gantry robots. It may be provided that the first robot and the second robot are arranged on a common gantry frame. It may be provided that the third robot is designed as a jointed-arm robot. It may be provided that the third robot is designed as a gantry robot, preferably structurally identical to the first and second gantry robots. It may be provided that the first robot, the second robot, and the third robot are arranged on a common gantry frame, in particular with four or six pillars. In this context, the respective working spaces of the three robots may partially overlap, in particular for handing over part-stacks at a handover location.

Preferred further developments of the invention (in short: further developments) as a method are described below. These may—where they do not technically exclude each other—also be combined.

One further development may be characterized in that the second robot sets down a part-stack on an intermediate storage (alternatively: buffer). It may be provided that a third robot with a further gripping apparatus lifts the part-stack off the intermediate storage and sets it down again elsewhere. In this case, the intermediate storage may also be considered a handover location. It may be provided that the setting down again takes place on a feeder of a further processing machine.

One further development may be characterized in that the second robot hands a part-stack over to a third robot with a further gripping apparatus without any intermediate setting down. In this context, the handover may take place freely “in the air.”

One further development may be characterized in that the intermediate storage comprises multiple intermediate storage locations. It may be provided that the intermediate storage locations are arranged next to one another in the horizontal direction, e.g., in the transverse direction Y. It may be provided that the intermediate storage locations are arranged on top of one another in the vertical direction, e.g., in the Z direction. It may be provided that the intermediate storage locations are arranged in an intermediate storage rack. The rack may comprise multiple rack levels on top of one another. It may be provided that the second robot fills the intermediate storage locations from a longitudinal side, and that the third robot empties the intermediate storage locations from an opposing longitudinal side or from a transverse side. It may be provided that the second robot fills the intermediate storage locations from a transverse side, and that the third robot empties the intermediate storage locations from an opposing transverse side or from a longitudinal side. As such, the two robots or their gripping apparatuses, respectively, may grasp the part-stack to be handed over offset by 90° or by 180°.

It may be provided that at least one intermediate storage location is designed as a cam surface. In this context, the cams (alternatively: protrusions, in particular in the Z direction) are preferably arranged and spaced apart from one another such that tines of a lower gripper can temporarily enter and exit below the part-stack and between the cams and set down or lift off the part-stack in this way. The cams may be arranged in a regular grid. Preferably, the tines may optionally enter and exit from one of the longitudinal sides or the transverse sides.

Other features which are considered as characteristic for the invention are set forth in the appended claims.

Although the invention is illustrated and described herein as embodied in a device and method for unstacking a stack, it is nevertheless not intended to be limited to the details shown, since various modifications and structural changes may be made therein without departing from the spirit of the invention and within the scope and range of equivalents of the claims. Also, individual developments and variations, as described above, may be considered inventions in themselves.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1 to 8 show preferred exemplary embodiments of the invention and of the further developments. In the figures, corresponding features are provided with the same reference symbols. Repeating reference symbols have been partially omitted in the figures for reasons of clarity.

FIG. 1 shows a perspective view of a preferred exemplary embodiment of a device according to the invention.

FIGS. 2 and 3 each show a side view.

FIG. 4 shows a top view of the same device.

FIG. 5 shows a side view of a preferred gripping apparatus.

FIG. 6 shows a side view of a preferred separating apparatus.

FIGS. 7A to 7F show a sequence when forming a gap.

FIG. 8 shows a side view of a schematic diagram of a preferred exemplary embodiment of a device according to the invention.

FIG. 9 shows a cam surface in two side views.

### DETAILED DESCRIPTION OF THE INVENTION

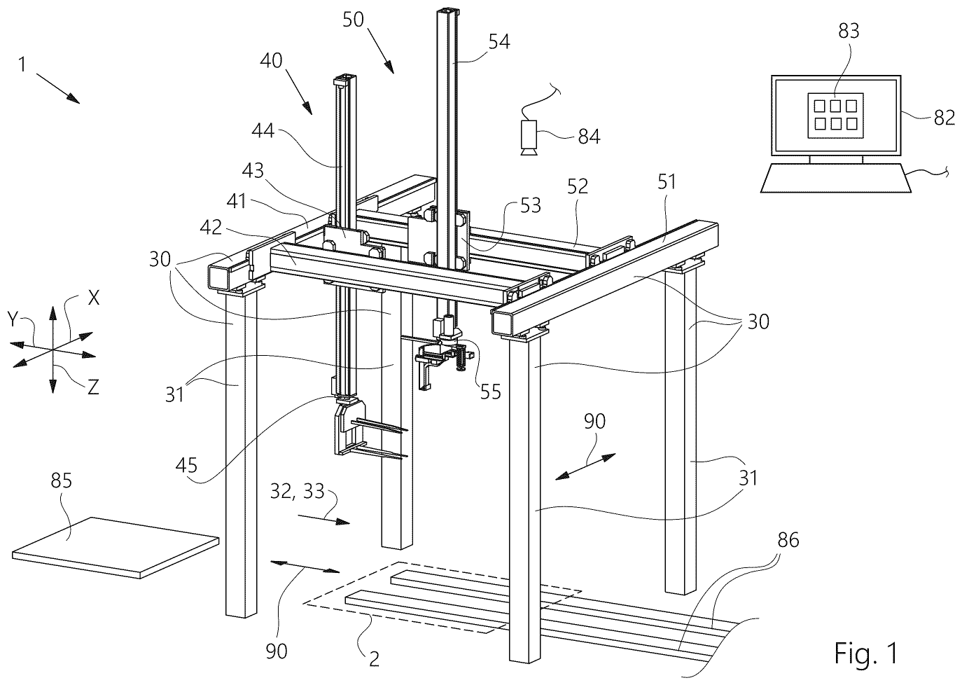

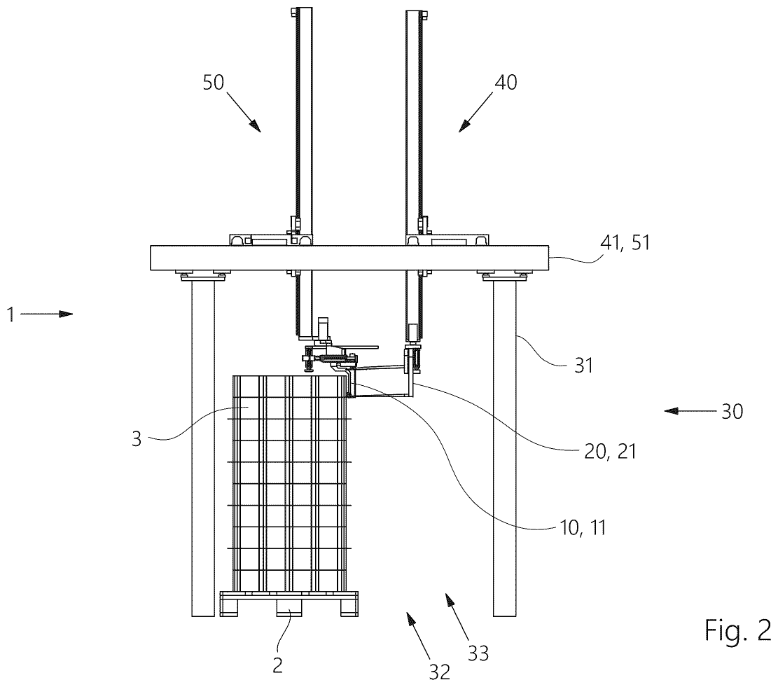

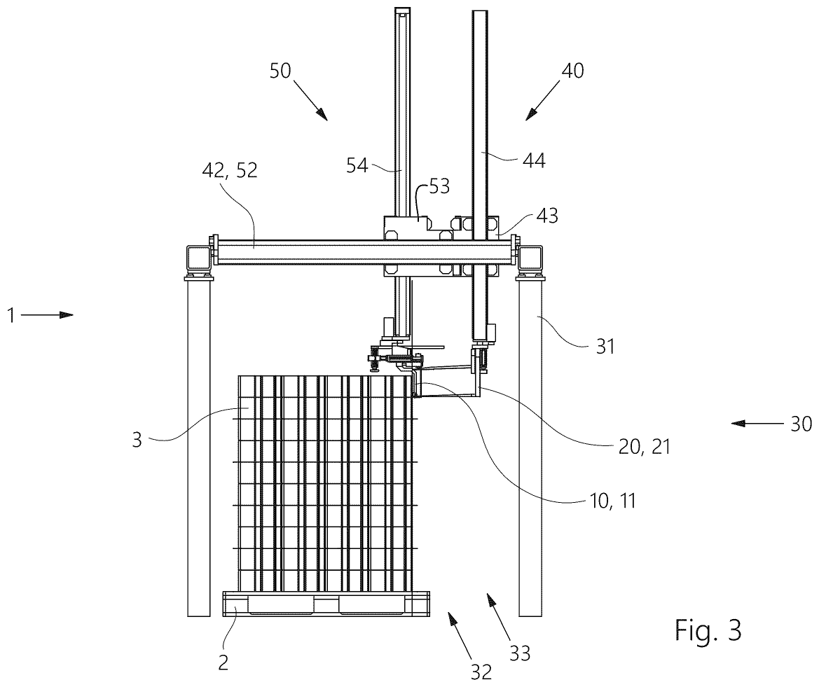

Referring now to the figures of the drawing in detail and first, in particular, to FIG. 1 thereof, there is shown a device 1 according to the invention for performing a method according to the invention for unstacking a pallet 2 or the stack 3 located thereon, respectively (cf. FIGS. 2 and 3). In this context, the stacked printed products 4 form respective part-stacks 5. The part-stacks 5, which may also be referred to as partial stacks 5 or sub-stacks 5, jointly form the stack 3.

The device 1 comprises a gantry frame 30 with four pillars, as an example, which define an intermediate space 32 with a working space 33 for robots located therein. The pallet 2 with the stack 3 may be moved into the working space 33 for unstacking, preferably in various movement directions 90. The gantry frame has a longitudinal side 75, a longitudinal side 76 opposing the same, a transverse side 77, and a transverse side 78 opposing the same; moving the pallet 2 may take place from one of the longitudinal sides or from one of the transverse sides into the working space. Moving the pallet 2 (in and also out) takes place, as an example, by means of an automated guided vehicle (AVG) 85, alternatively by means of a pallet conveying apparatus 86, preferably arranged under the floor. The pallet 2 may also be moved manually using a lift truck.

The device 1 comprises a first robot 40 which is designed as a gantry robot on the gantry frame 30 with a first longitudinal guide 41 (in the X direction), a first transverse guide 42 (in the Y direction) movable in the X direction, a first vertical guide 43 (in the Z direction) movable in the Y direction, a first vertical support 44 (in the Z direction), and a first axis of rotation 45 at the end of the vertical support 44. The first robot 40 may carry out movements 98a in the X, Y, and/or Z directions.

The device 1 further comprises a second robot 50 which is likewise designed as a gantry robot on the gantry frame 30, however, with a second longitudinal guide 51 (in the X direction; in the example identical to the first longitudinal guide 41), a second transverse guide 52 (in the Y direction) movable in the X direction, a second vertical guide 53 (in the Z direction) movable in the Y direction, a second vertical support 54 (in the Z direction), and a second axis of rotation 45 at the end of the vertical support. The second robot 50 may carry out movements 98b in the X, Y, and/or Z directions.

The two robots 40 and 50, as gantry robots, comprise the usual drives for the respective X, Y, and Z movements of their tools.

The two robots 40 and 50 or their coordinated and collision-free movements, respectively, are controlled by the digital computer 82. It has access to the digitally stored set-down pattern 83 which is to be used for the stack 3 currently to be disassembled. A digital camera 84 is also present on the gantry frame 30 to sense the stack 30 and to be able to detect deviations from the set-down pattern 83 and correct them as needed.

The same device 1 is shown from the longitudinal side 75 in FIG. 2, and from the transverse side 77 in FIG. 3.

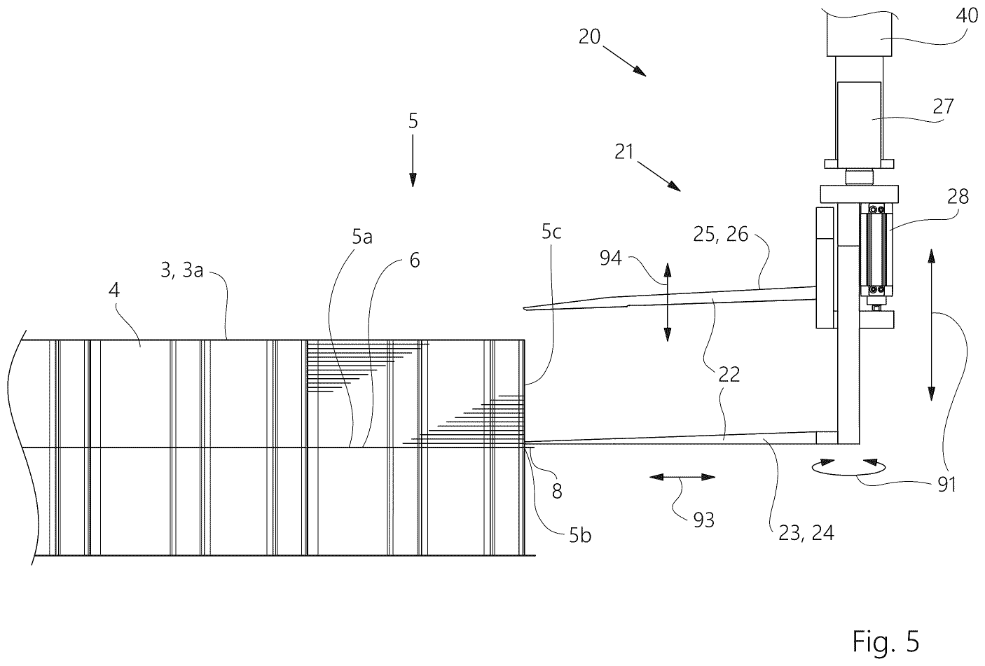

It can be gathered from FIGS. 1 to 3 jointly with FIG. 5 that a mobile gripping apparatus 20, which comprises a gripping head 21 for gripping one part-stack 5 each, is arranged on the first robot 40. The gripping head 21 as a robot-guided tool is movable or positionable, respectively, in the X, Y, and Z directions (movements 91 and 92) and rotatable about the Z axis. The gripping head 21 comprises a gripper pair 22 consisting of a lower gripper 23 with tines 24 and a vertically movable upper gripper 25 with tines 26. The gripping apparatus 20 comprises a controllable drive 27 for rotationally moving the gripping head 21. The gripping head 21 comprises a controllable drive 28 for translationally moving the upper gripper 28 (movement 94), i.e., for grasping a part-stack 5.

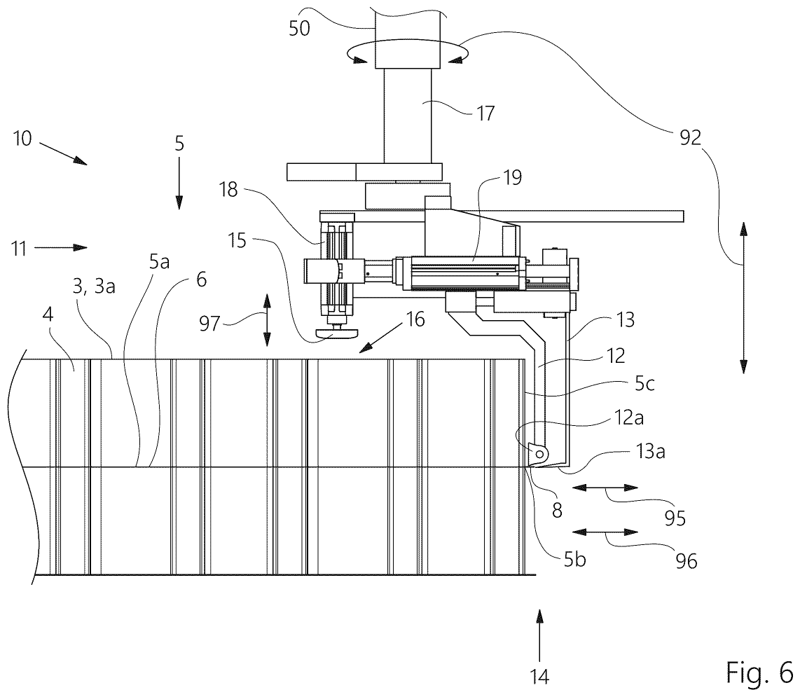

It can also be gathered from FIGS. 1 to 3 jointly with FIG. 6 that a mobile separating apparatus 10, which comprises a separating head 11 for separating one part-stack 5 each, is arranged on the second robot 50. The separating head 11 as a robot-guided tool is movable or positionable, respectively, in the X, Y, and Z directions and rotatable about the Z axis. The separating head 11 comprises a first lifter 12 and a second lifter 13 as well as a presser 15. The separating apparatus 10 comprises a controllable drive 17 for rotationally moving the separating head 11. The separating head 11 comprises a controllable drive 18 for translationally moving the presser 15 and a controllable drive 19 for translationally moving both lifters 12 and 13.

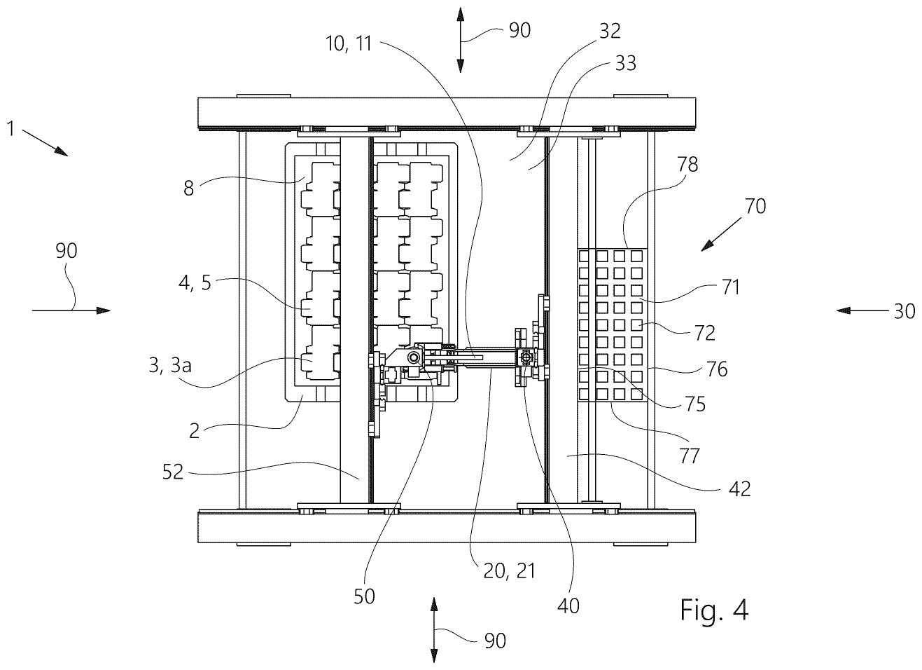

FIG. 4 shows the same device 1 in a top view. In the working area of at least the gripping apparatus 20, an intermediate storage 70 is located which is designed as a horizontally positioned cam surface 71 with cams 71 reaching upwards and arranged in a grid shape and on which at least one part-stack 5 may be temporarily set down and in this way intermediately stored until it is picked up again. The intermediate storage 70 is part of an intermediate storage rack 73 with at least two intermediate storage locations 74 sufficiently spaced apart on top of one another and from one another (in accordance with the maximum height of the part-stacks 5 to be handled), wherein only the topmost intermediate storage location 74 is discernible in FIG. 4. It is also discernible from the top view that the separating head 11 and the gripping head 21, and in particular their lifters and tines, are designed such that those elements can be moved without any collisions when separating and gripping, for example, the lifters may temporarily be located between the tines. Finally, it is discernible that the two transverse guides 42 and 52 of the robots 40 and 50 cannot be moved past one another, i.e., the control of the movements must take this into account. Alternatively, it may also be provided that multiple longitudinal guides are present, e.g., on top of one another, so that moving past one another is possible after all.

FIG. 5 shows the gripping apparatus 20 with the gripping head 21, gripper pair 22, lower gripper 23, lower gripper tines 24, upper gripper 25, upper gripper tines 26, drive 27, and drive 28. For gripping and lifting off the part-stack 5, the open gripper pair 22 enters the stack 3 and is then closed (lowering the tines 26). Before that, however, the part-stack 5 is separated from the stack 3 (cf. figures sequence 7A to 7F).

FIG. 6 shows the separating apparatus 10 with the separating head 11, first lifter 12, second lifter 13, presser 15, as well as the drives 17, 18, and 19. Further, the effective area of the presser 16 is implied. The two lifters 12 and 13 are movable to horizontal settings 14 for separating one part-stack 5 (cf. figures sequence 7A to 7F).

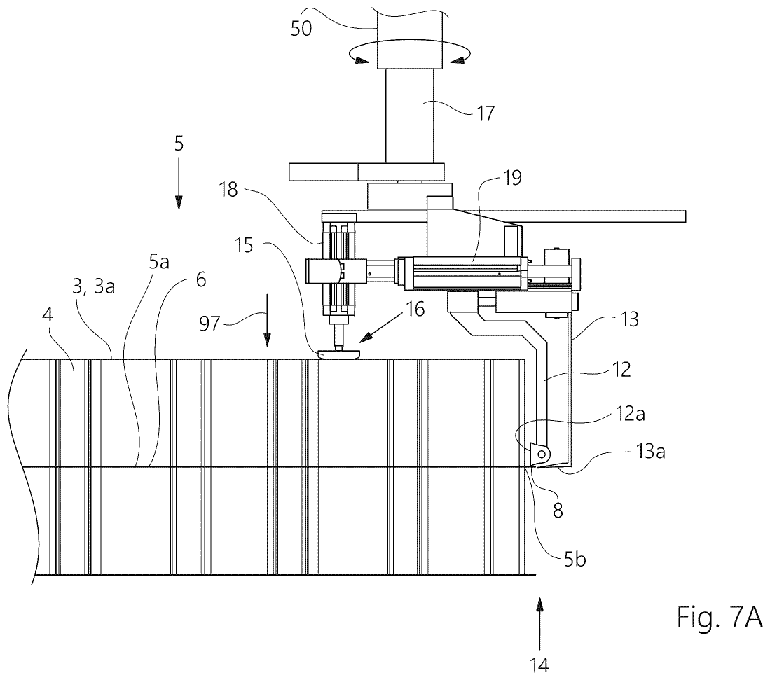

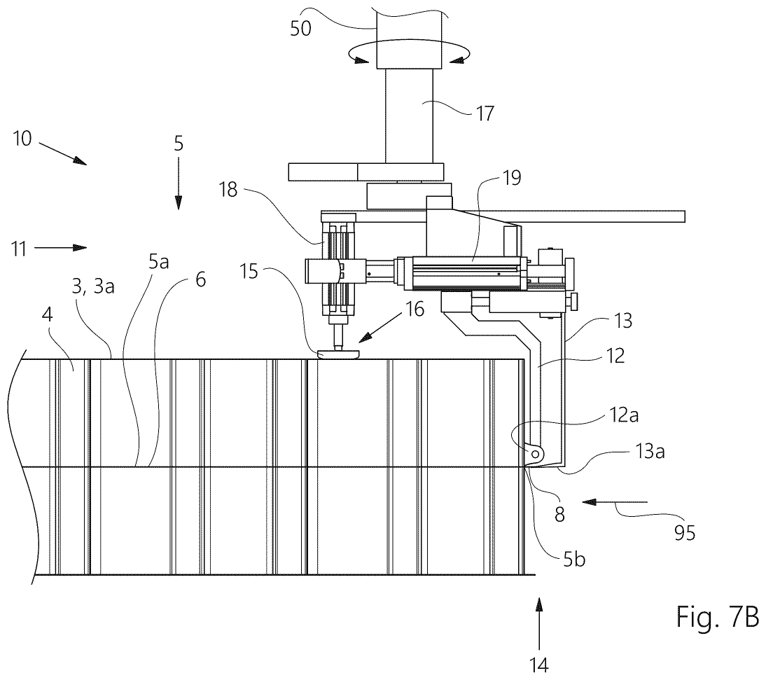

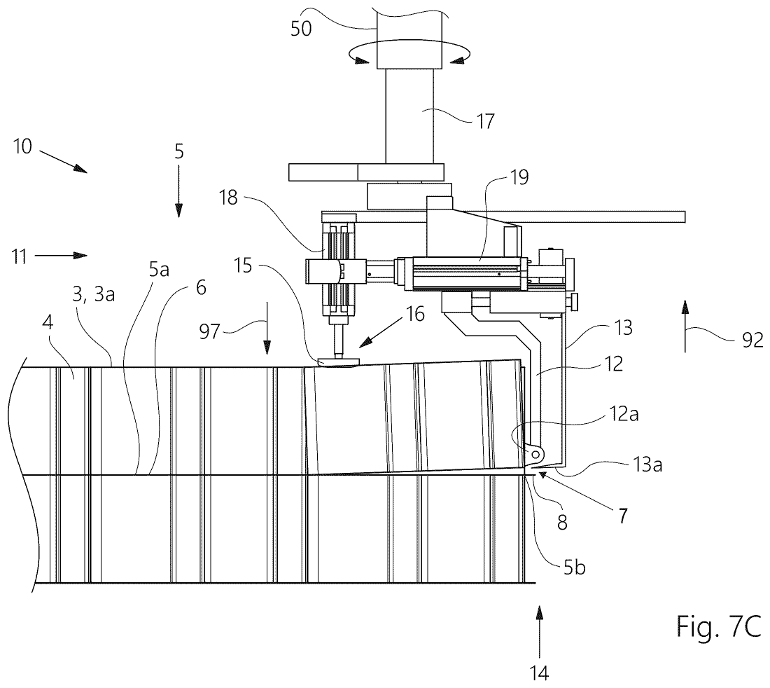

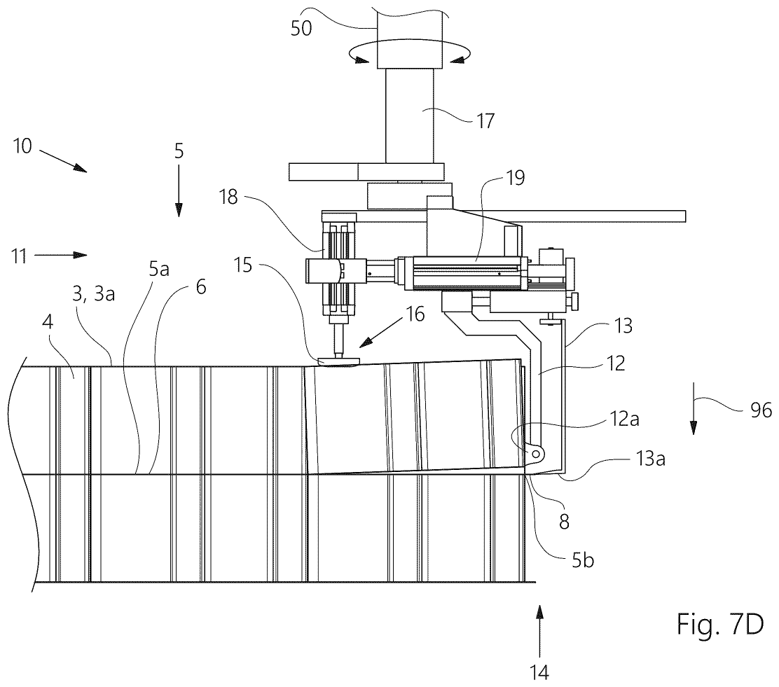

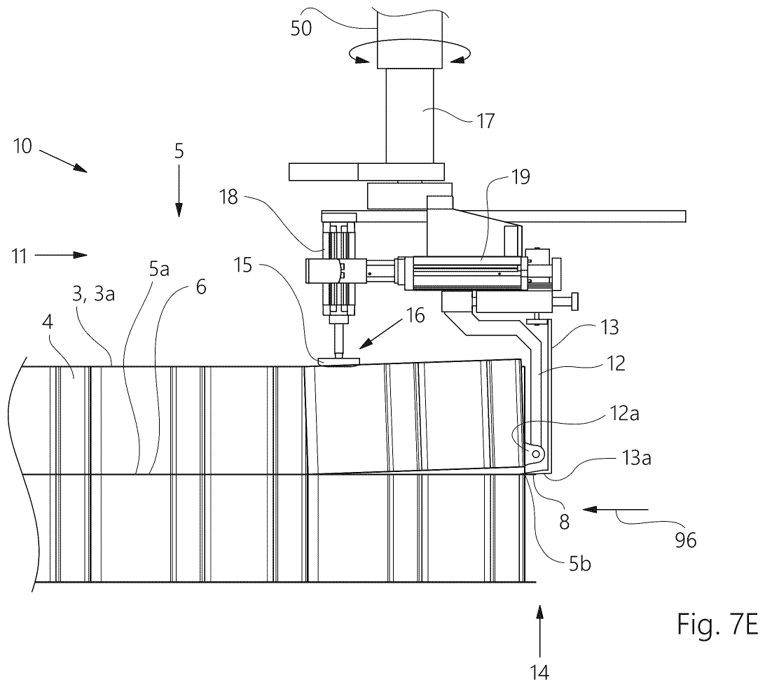

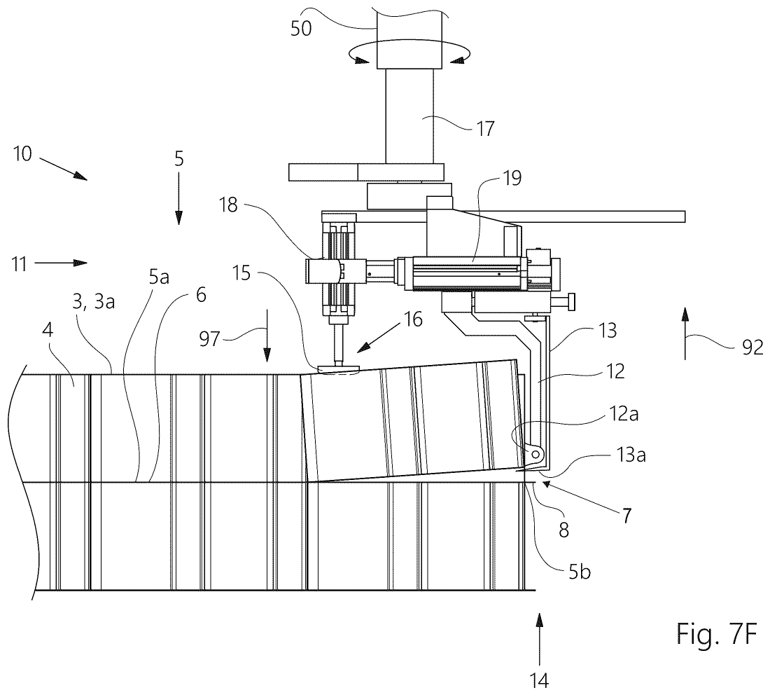

FIGS. 6 and 7A to 7F illustrate a sequence of steps when forming a gap 7:
FIG. 6: The separating apparatus 10 is vertically and horizontally moved close to the part-stack 5 to be handled (movement 92).
FIG. 7A: The presser 15 is moved downwards and presses the part-stack 5 downwards in its effective area 16 onto the stack 3 (movement 97) or onto the top 3a of the (residual) stack 3 located below the part-stack 5, respectively.
FIG. 7B: The first lifter 12 is horizontally moved to a vertical side 5c of the part-stack 5 and touches it (movement 95). In this context, the first lifter 12 or its contact element 12a, respectively, is pressed against the side 5c by means of a spring.
FIG. 7C: The robot 50 lifts the gripping head 21 (movement 92); at the same time, the presser 15 is moved downwards by a corresponding distance (movement 97). In this context, the first lifter 12 slightly lifts the part-stack, and this gives rise to a gap 7 between the horizontal bottom 5a or the bottommost product 6 of the part-stack 5, respectively, and the top 3a.
FIG. 7D: The second lifter 13 is lowered to the level of the gap 7 (movement 96); if an intermediate layer 8 is present in the stack 3: to the intermediate layer.
FIG. 7E: The second lifter 13 or its lifting element 13a, respectively, is moved horizontally into the gap 7 (movement 96 in FIG. 7E).
FIG. 7F: The robot 50 lifts the gripping head 21 along with the second lifter 13 (movement 92); at the same time, the presser 15 is moved downwards by a corresponding distance again (movement 97). In this context, the gap 7 already existing is enlarged. The part-stack 5 is thus sufficiently separated from the stack in the area of its bottom edge 5b so that a lower gripper tine 24 of the gripping head 21 can enter the gap 7 and then preferably completely below the part-stack 5 for lifting off the part-stack 5.

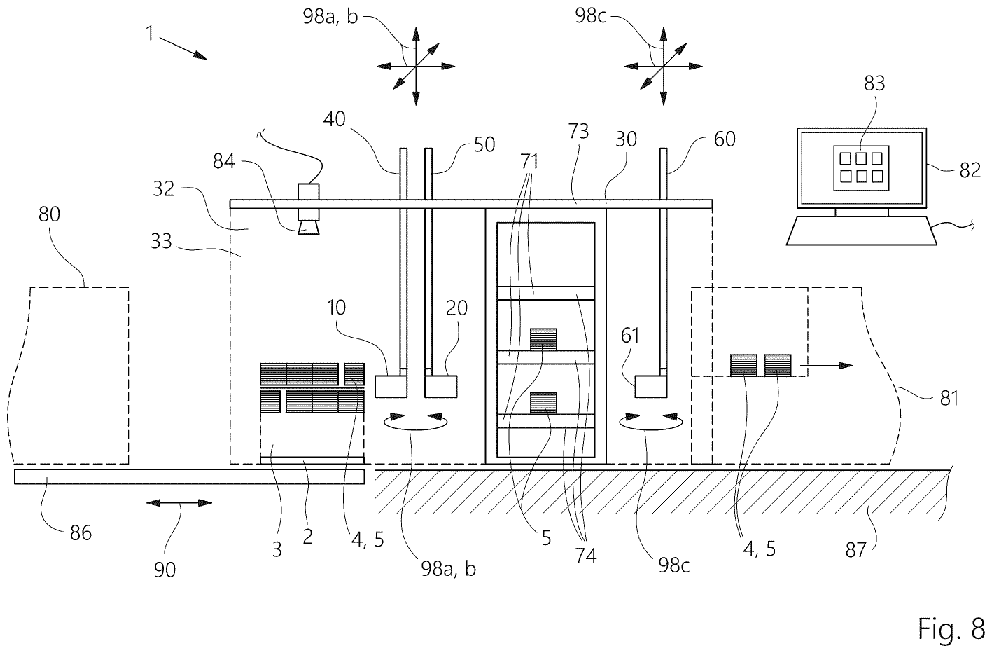

FIG. 8 shows the previously described device 1 for unstacking a pallet 2 or the stack 3 of part-stacks 5 located thereon, respectively, in an environment of a graphics plant, e.g., a printing shop, with at least two machines 80 and 81. The machine 80 is, e.g., a printing machine with a punching module and generates printed and punched products 4, e.g., folding-carton blanks which are unstacked in part-stacks 5 utilizing a fittingly selected set-down scheme 83 to form a stack 3, preferably employing a jointed-arm robot, e.g., what is known as a cobot. The machine 81 is, e.g., a folding-carton gluing machine which is supplied with the part-stacks 5 lifted off the stack 3. An (underfloor) pallet conveying apparatus 86, which conveys the loaded pallets 2 from the machine 80 into the working space 33 and returns emptied pallets, is present in the floor 87 of the production site.

The first gantry robot 40 with the gripping apparatus 20 and the second gantry robot 50 with the separating apparatus 10 are movably accommodated on the gantry frame 30. In addition, a third robot 60 as a gantry robot with a further gripping apparatus 61 (similar or identical to the gripping apparatus 20) is accommodated on the gantry frame (alternatively: on an extension of the gantry frame or on a further gantry frame). Alternatively, the third robot 60 may also be designed as a jointed-arm robot, e.g., as what is known as a cobot. In operation, the robots carry out movements 98a, 98b, and 98c.

The device 1 has an intermediate storage rack 73 with multiple intermediate storage locations 74 arranged on top of one another; in the example shown, there are three. The gripping apparatus 20 sets down part-stacks 5 on cam surfaces 71 of the rack 73, and the further gripping apparatus 61 picks them up again from there and moves them to the machine 81. The intermediate storage rack 73 may be utilized as a buffer, i.e., filled with stock and emptied as needed. As appropriate, multiple part-stacks 5 may be buffered on each cam surface 71.

Control of the device 1, i.e., in particular of the coordinated robot movements, takes place by means of the digital computer 82 utilizing the stored set-down scheme 83 and a camera 84, as appropriate, which senses the working space 33.

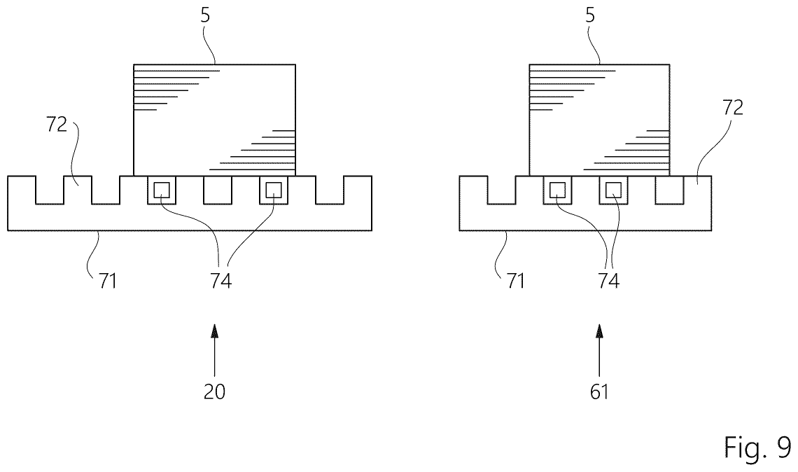

FIG. 9 shows a cam surface 71 with cams 72 or a cam rest, respectively: from a longitudinal side on the left, and from a transverse side on the right. On the left, it is discernible that the lower gripper tines 24 of the gripping apparatus 20 enter (and then exit) between the cams 72 when setting down a part-stack 5 on the cams 72. On the right, it is discernible that corresponding tines of the further gripping apparatus 61 likewise enter between the cams 72 when lifting the part-stack 5 off the cams 72. Setting the part-stack 5 down and picking it up again thus takes place once from the longitudinal side and once from the transverse side, that is, offset by 90°. In this way, the part-stack 5 may be moved further while rotated about a vertical axis and supplied to a machine. Alternatively, the picking up again may also take place from the longitudinal side or the opposing longitudinal side, that is, without rotating.

The following is a summary list of reference numerals and the corresponding structure used in the above description of the invention:
1 device
2 pallet
3 stack
3a top of the stack
4 printed products
5 part-stack, sub-stack, partial stack
5a (horizontal) bottom of the part-stack
5b bottom edge of the part-stack
5c vertical side of the part-stack
6 bottommost product of the part-stack
7 gap
8 intermediate layer
10 separating apparatus
11 separating head
12 first lifter
12a contact element
13 second lifter
13a lifting element
14 horizontal settings
15 presser
16 effective area of the presser
17 controllable drive for the separating head (rotation)
18 controllable drive for the presser (translation)
19 controllable drive for the lifters (translation)
20 gripping apparatus
21 gripping head
22 gripper pair
23 lower gripper
24 tines
25 upper gripper
26 tines
27 controllable drive for the gripping head (rotation)
28 controllable drive for the upper gripper (translation)
30 gantry frame
31 pillar
32 intermediate space
33 working space
40 first robot, in particular gantry robot
41 first longitudinal guide
42 first transverse guide
43 first vertical guide
44 first vertical support
45 first axis of rotation
50 second robot, in particular gantry robot
51 second longitudinal guide
52 second transverse guide
53 second vertical guide
54 second vertical support
55 second axis of rotation
60 third robot, in particular gantry robot or jointed-arm robot
61 further gripping apparatus
70 intermediate storage
71 cam surface
72 cam
73 intermediate storage rack
74 intermediate storage location(s)
75 longitudinal side
76 opposing longitudinal side
77 transverse side
78 opposing transverse side
80 machine, in particular folding machine
81 further processing machine, in particular binder or stitcher
82 digital computer
83 digital set-down scheme
84 sensing apparatus, in particular camera
85 AGV (automated guided vehicle)
86 pallet conveying apparatus
87 floor
90 movement(s) of the stack
91 movement(s) of the gripping apparatus/gripping head
92 movement(s) of the separating apparatus/separating head
93 movement(s) of the lower gripper
94 movement(s) of the upper gripper
95 movement(s) of the first lifter
96 movement(s) of the second lifter
97 movement(s) of the presser
98a movement(s) of the first robot
98b movement(s) of the second robot
98c movement(s) of the third robot
X horizontal longitudinal direction
Y horizontal transverse direction
Z vertical upwards direction

1. A device for unstacking a stack, wherein the stack is formed of part-stacks of flat printed products arranged next to one another and on top of one another, the device comprising:
a separating apparatus configured for forming a gap between a respective part-stack and a remainder of the stack;
a gripping apparatus for gripping the respective part-stack via the gap formed between the respective part-stack and the remainder of the stack;
a first robot configured to move said gripping apparatus during the unstacking; and
a second robot configured to move said separating apparatus separately.

2. The device according to claim 1, wherein said gripping apparatus is a gripping head movably mounted to said first robot.

3. The device according to claim 1, wherein said separating apparatus is a separating head movably mounted to said second robot.

4. The device according to claim 1, wherein said gap is formed between a bottom of a respective part-stack and a top of the stack located underneath the respective part-stack.

5. The device according to claim 1, wherein said separating head comprises a first lifter for lifting the part-stack in some areas and for generating the gap.

6. The device according to claim 5, wherein said first lifter is disposed to touch the part-stack at a vertical side during lifting.

7. The device according to claim 1, wherein said separating head comprises a vertically movable second lifter for lifting the part-stack in some areas and for generating the gap.

8. The device according to claim 7, wherein said second lifter is configured to touch the part-stack at a horizontal bottom during lifting.

9. The device according to claim 1, wherein said separating head comprises a vertically movable presser.

10. The device according to claim 1, which comprises a digital computer configured to control both a movement of said first robot and an activation of said gripping apparatus and a movement of said second robot and an activation of said separating apparatus, and to thereby first separate the part-stack from the stack and subsequently grip the part-stack.

11. The device according to claim 10, wherein the stack is constructed in accordance with a set-down scheme for the part-stacks, and wherein said digital computer is configured to control both the movement of said first robot and the movement of said second robot during disassembling of the stack with recourse to the set-down scheme.

12. The device according to claim 10, wherein said first robot is a first gantry robot.

13. The device according to claim 10, wherein said second robot is a second gantry robot.

14. The device according to claim 10, wherein movements of said gripper apparatus and movements of said separating apparatus span a common working space.

15. The device according to claim 14, wherein the stack is entirely, or at least in part, placed in the working space for disassembling.

16. The device according to claim 10, wherein said first robot and said second robot are gantry robots and are mounted to a common gantry frame.

17. The device according to claim 16, wherein said common gantry frame comprises multiple pillars which span an intermediate space.

18. The device according to claim 17, wherein the working space is in the intermediate space.

19. A device for unstacking a stack, wherein the stack is formed of part-stacks of flat printed products arranged next to one another and on top of one another, the device comprising:
a first robot having a gripper apparatus; and
a second robot having a separating apparatus.

20. The device according to claim 19, further comprising a third robot having a further gripping apparatus.

21. The device according to claim 20, wherein said first robot, said second robot, and said third robot are arranged on a common gantry frame.

22. A method for unstacking a stack, the method comprising:
providing the stack formed of part-stacks of flat printed products arranged next to one another and on top of one another;
first individually separating the part-stacks from the stack by forming a gap with a separating apparatus that is arranged on a first robot and moved by the first robot; and
subsequently gripping and lifting off the part-stacks by a gripping apparatus arranged on a second robot and moved by the second robot.

23. The method according to claim 22, which comprises setting down the part-stack on an intermediate storage device by the second robot.

24. The method according to claim 23, which comprises lifting the part-stack off the intermediate storage device by a third robot with a further gripping apparatus and setting the part-stack down elsewhere.

25. The method according to claim 22, wherein the second robot hands a part-stack over to a third robot with a further gripping apparatus without any intermediate setting down.

26. The method according to claim 22, wherein the intermediate storage device comprises multiple intermediate storage locations.

27. The method according to claim 26, wherein the intermediate storage locations are arranged in an intermediate storage rack.

28. The method according to claim 26, wherein at least one intermediate storage location is designed as a cam surface.
